(19) United States
(12) Patent Application Publication
(10) Pub. No.: US 2026/0336570 A1
(43) Pub. Date: Oct. 29, 2026

(54) MODULAR AND CONFIGURABLE STRUCTURE INCLUDING A VACUUM SYSTEM FOR A VEHICLE CARWASH

(71) Applicant: Motor City Wash Works, Inc., Wixom, MI (US)

(72) Inventors: Lionel Belanger, Northville, MI (US); Doug Calvin, Livonia, MI (US); Michel LeCourt, Westland, MI (US)

(73) Assignee: Motor City Wash Works, Inc., Wixom, MI (US)

(21) Appl. No.: 19/658,857

(22) Filed: Apr. 27, 2026

Related U.S. Application Data
(60) Provisional application No. 63/795,050, filed on Apr. 25, 2025.

(51) Int. Cl. B60S 3/00; E04H 12/22; E04H 15/34

(52) U.S. Cl. CPC B60S 3/008; E04H 12/223; E04H 15/34

(57) ABSTRACT

A modular structure with improved structural and functional elements. A vertical support beam comprises interlocking elongated plates forming a rounded beam with longitudinal valleys. A lateral support beam features an internal compartment for airflow, a canopy attachment interface, and a vacuum connection interface, enabling airflow through the beam. A debris collection apparatus includes a cylindrical body with an internal collection chamber, a vacuum inlet port with a valve, and a base compartment for easy debris removal. These elements enhance the structural integrity, functionality, and ease of maintenance of the modular structure.

### CROSS-REFERENCE TO RELATED APPLICATIONS

This application is a Non-Provisional Patent Application, which claims the benefit of U.S. Provisional Patent Application 63/795,050, filed Apr. 25, 2025, the entire contents of which are incorporated herein by reference.

### TECHNICAL FIELD

The disclosure generally relates to modular and configurable structures, more particularly to modular and configurable structures adapted for use with a carwash, including a vacuum system.

### BACKGROUND

Various modular and configurable structures exist for various applications. In a carwash setting, structures have applications to accommodate various carwash equipment. The carwash equipment includes washing and drying equipment typically in a housing, such as a building. The carwash equipment may also include a vacuum system, which may exist exterior to a carwash building.

For example, known structures used in a carwash can be found in U.S. Pat. Nos. 7,753,326, 7,784,756, and 8,512,835, which are incorporated herein by reference. However, there are opportunities for further improvement to such structures.

The aforementioned vacuum system typically includes one or more stations for a vehicle to approach the station and allow a user to vacuum clean the vehicle. Such systems may include individual vacuum motors and accompanying equipment. Other systems offer the advantage of a centralized vacuum motor servicing multiple stations. However, there are multiple areas of possible improvement for such vacuum systems. Most existing systems have an unappealing appearance, which can be improved to attract more customers. Furthermore, current vacuum systems make it difficult to deactivate a single vacuum station among several associated with a centralized vacuum motor. This is particularly problematic when a user loses a valuable item during the vehicle vacuuming process. Typically, a worker must turn off the central system and proceed to take apart components of the vacuum systems until the valuable item is found. Emptying the debris collector from the vacuum system also offers areas for improvement.

Therefore, there are multiple opportunities to improve the structures of carwash cleaning systems, including a vacuum system that addresses the limitations and disadvantages of current systems.

### SUMMARY

It is an advantage of the present disclosure to provide a modular and configurable structure including a vacuum system for a carwash that is better adapted to a carwash environment, particularly including a vacuum system with modularity, configurability, improved aesthetics, improved vacuum servicing including the ability to interrupt and retrieve lost articles, and an ability to more easily empty the vacuum system of debris. The improvements include making the structures modular and adaptable for various applications, including modifying how the structure is configurable. Added features include lighting elements and coverings to enhance the structure's aesthetic appeal.

It is another advantage of the present disclosure to provide a vacuum system with a debris separator including a separator quick connect for allowing easy emptying and reattachment of a debris collector.

It is another advantage of the present disclosure to provide a vacuum system with a separator shutoff valve that is adapted for easy shutoff by a user without shutting down the entire vacuum system.

It is another advantage of the present disclosure to provide modularity and configurability of the structure and vacuum system to accommodate different orientations of a plurality of separators connected in unison. This includes differing orientations to accommodate how vehicles are parked, including parallel and angled parking.

It is another advantage of the present disclosure to provide a vacuum boom made of extruded material, including a suction tube, utility openings, and utility slots, thereby further enabling modularity and configurability of the system. The vacuum boom can serve multiple functions, including as a vacuum source for multiple vacuum stations, a support structure for the entire vacuum system, and support for a canopy and aesthetic coverings, including lights.

Another advantage of the present disclosure is the provision of a modular and configurable system that can withstand high winds.

It is another advantage of the present disclosure to provide a modular and configurable system that features several extruded aluminum parts that provide a strong and lightweight structure suitable for multiple carwash applications.

It is another advantage of the present disclosure to provide a modular structure of lightweight components that are easy to ship to a location for assembly without the high costs of shipping heavy or bulky equipment.

It is another advantage of the present disclosure to provide a modular structural components having recessed areas adapted to receive a plastic sheeting for further customization and branding. The system can be further adapted to include lighting between the structural components and the plastic sheeting thus allowing for offering an aesthetically pleasing lighting of the structure.

Other advantages will become clear in relation to the detailed description of the invention, including the drawings.

In accordance with the above and other advantages of the present disclosure, a modular and customizable structure including a vacuum system for a carwash. In one general aspect, a vertical support beam apparatus may include a first pair of identical elongated plates, each plate having a first lateral edge and a second lateral edge, and a first groove along the first lateral edge and a second groove along the second lateral edge. The vertical support beam apparatus may also include a second pair of identical elongated plates, each plate having a first lateral edge and a second lateral edge, and a first protrusion along the first lateral edge and a second protrusion along the second lateral edge configured to interlock with the first groove and second groove of the first pair of plates. The vertical support beam apparatus may furthermore include where the first lateral edge of each plate in the first pair of plates is interlocked with the first lateral edge of a plate in the second pair of plates and the second lateral edge of each plate in the first pair of plates is interlocked with the second lateral edge of a plate in the second pair of plates to form an assembled beam. The vertical support beam apparatus may also include a place where the assembled beam has a rounded overall shape in cross-section. The vertical support beam apparatus may, moreover, include a feature where the assembled beam defines two opposing longitudinal valleys along its outer surface.

In another general aspect, a lateral support beam may include a single-piece elongated beam member defining an internal compartment extending longitudinally along the length of the beam member, the internal compartment configured to facilitate airflow. The lateral support beam support beam apparatus may also include a canopy attachment interface on an external surface of the elongated beam member, configured to support an overhead canopy. Apparatus may furthermore include a vacuum connection interface on the elongated beam member, configured for hinged connection to a vacuum source. The lateral support beam may, in addition, include a feature where the internal compartment is in fluid communication with the vacuum connection interface, such that the application of a vacuum at the vacuum connection interface draws air through the internal compartment along the length of the elongated beam member.

In a further general aspect, a debris collection apparatus may include a cylindrical body defining an internal collection chamber for receiving debris. The debris collection apparatus may also include a vacuum inlet port located on the cylindrical body, the vacuum inlet port configured for connection to a vacuum source. The debris collection apparatus may furthermore include a valve mechanism operatively associated with the vacuum inlet port, the valve mechanism configured to selectively open and close the vacuum inlet port to control airflow from a vacuum source. The debris collection apparatus may, in addition, include a base compartment located at a lower portion of the cylindrical body, the base compartment configured for removable access to the internal collection chamber. The debris collection apparatus may moreover include an upper portion of the cylindrical body configured to be positioned at an elevated height relative to a support surface, such that the base compartment is accessible for the removal of debris without requiring substantial vertical displacement of the entire canister.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a schematic-type perspective view of a fully assembled unit of a modular carwash, as described herein;

FIGS. 2A-2C are a top view, side view, and front view, respectively, of a component of a vertical support beam apparatus, as described herein;

FIGS. 3A-3C are a top view, side view, and front view, respectively, of a component of the vertical support beam apparatus, as described herein;

FIGS. 4A-4C are a top, perspective, and partial view, respectively, of the assembled vertical support beam apparatus, as described herein;

FIGS. 5A-5B are a top and side view, respectively, of the lateral support beam, as described herein;

FIGS. 6A-6B are a front perspective view and rear perspective view of the connection between the vertical support beam apparatus and the lateral support beam, as described herein;

FIGS. 7A-7B are a front perspective cross-sectional view and rear perspective cross-sectional view of the connection between the vertical support beam apparatus and the lateral support beam, as described herein;

FIGS. 8A-8B are lateral cross-sectional views of the vacuum connection at the base and tip, respectively, of the lateral support beam, as described herein;

FIGS. 9A-9B are a front perspective view and a vertical cross-sectional view, respectively, of the vacuum connection at the base of the lateral support beam, as described herein;

FIG. 10 is a top-down view of a fully assembled canopy supported by a lateral support beam, as described herein;

FIGS. 11A-11C are a perspective, cross-sectional, and partial view, respectively, of the debris collection apparatus, as described herein;

FIGS. 12A-12B are a bottom-sealed view and a bottom unsealed view, respectively, of the debris collection apparatus, as described herein;

FIGS. 13A-13C are a vertical cross-sectional view of the canister, a perspective view, and cross-sectional view of the debris separator valve of the debris collection apparatus, as described herein;

FIGS. 14A-14C are close-up views of the canister attachment mechanism in multiple arrangements of the debris collection apparatus, as described herein;

FIGS. 15A-15C are a perspective view, top view, and side view, respectively, of a bottom hinge for connecting the debris collection apparatus to the vertical support beam apparatus, as described herein;

FIGS. 16A-16C are a perspective view, top view, and side view, respectively, of a top hinge for connecting the debris collection apparatus to the vertical support beam apparatus, as described herein; and

FIGS. 17A-17C are a top view, side view, and front view, respectively, of a component of a vertical support beam apparatus, as described herein.

### DETAILED DESCRIPTION

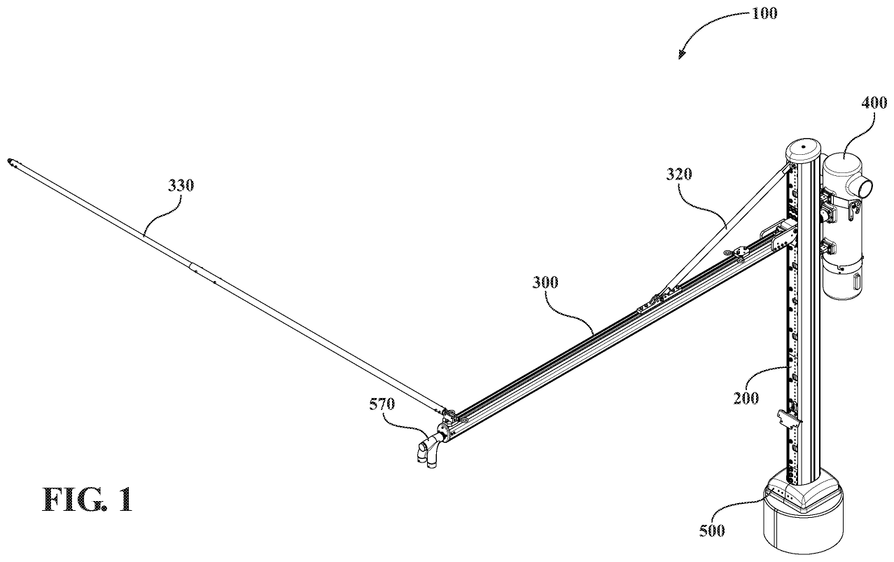

With reference to FIG. 1, in a non-limiting embodiment, a unit of modular structure for a carwash 100 comprises a vertical support beam apparatus 200, a lateral support beam 300, a debris collection apparatus 400, and a base 500. In some embodiments, the lateral support beam 300 may include a secondary lateral support beam 320 that strengthens the structural support of a unit of the modular structure 100. In some embodiments, the lateral support beam 300 has a canopy support beam 330 attached thereto, which can be part of the structural support of an overhead canopy for the unit of the modular structure 100.

It should be appreciated that the modular structure 100 is adapted to be connected to additional units of the modular structure 100 to form an interactive group of such units. For example, some carwashes may have room and need for multiple modular structures 100, while others may need just one or two. It is an advantage of the disclosure that it allows easy connectivity between more than one modular structure. It is another advantage to be able to leverage the structures'connectivity over time. In other words, a carwash can add units as needed. In any of the above-described scenarios, the units individually and collectively provide important improvements and advantages as described.

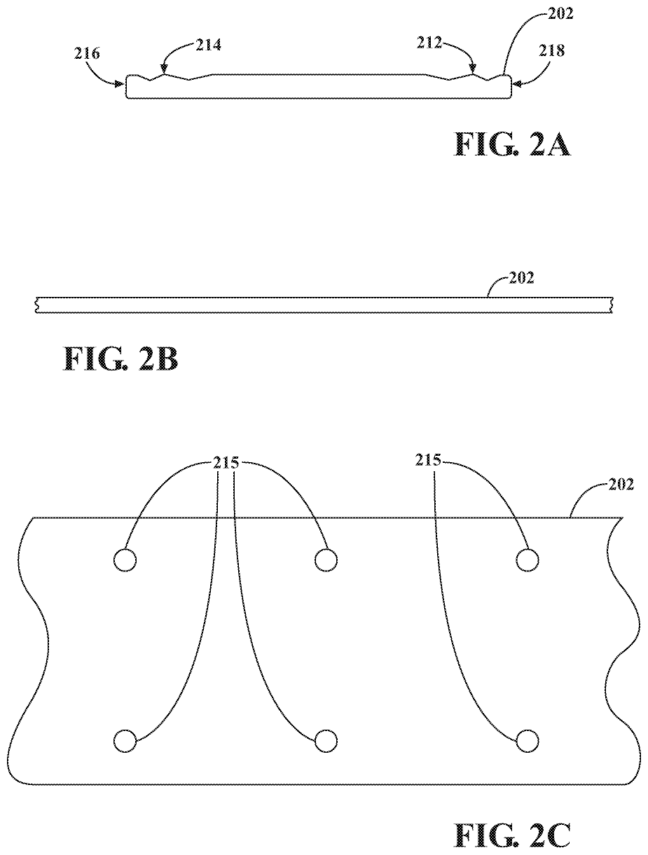

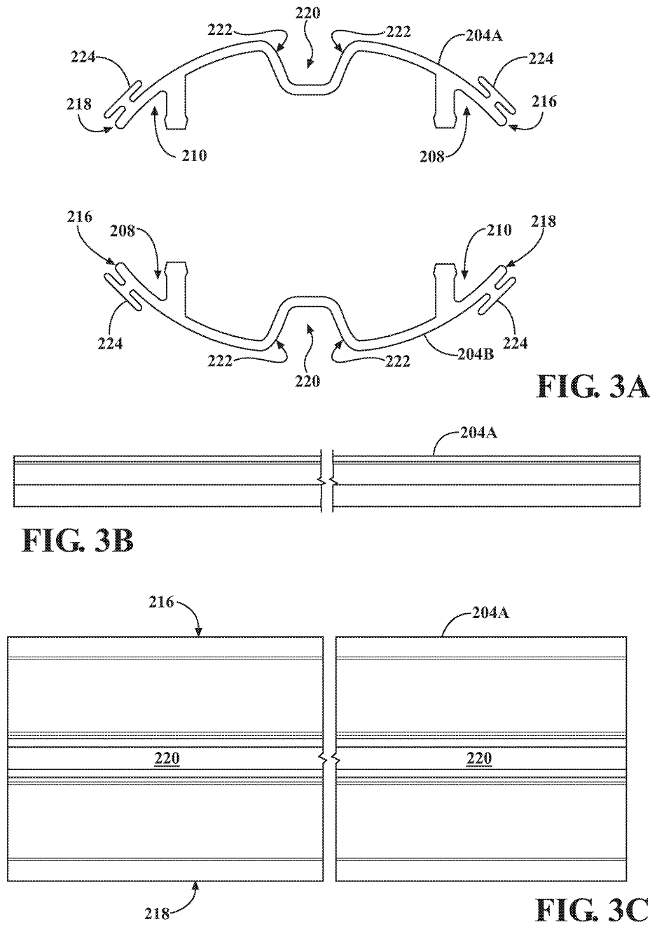

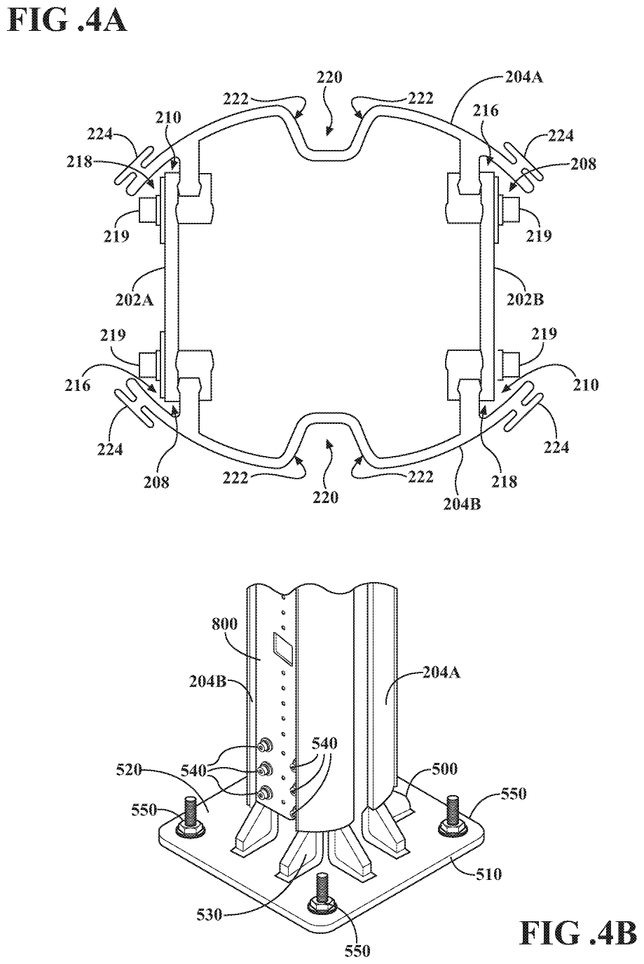

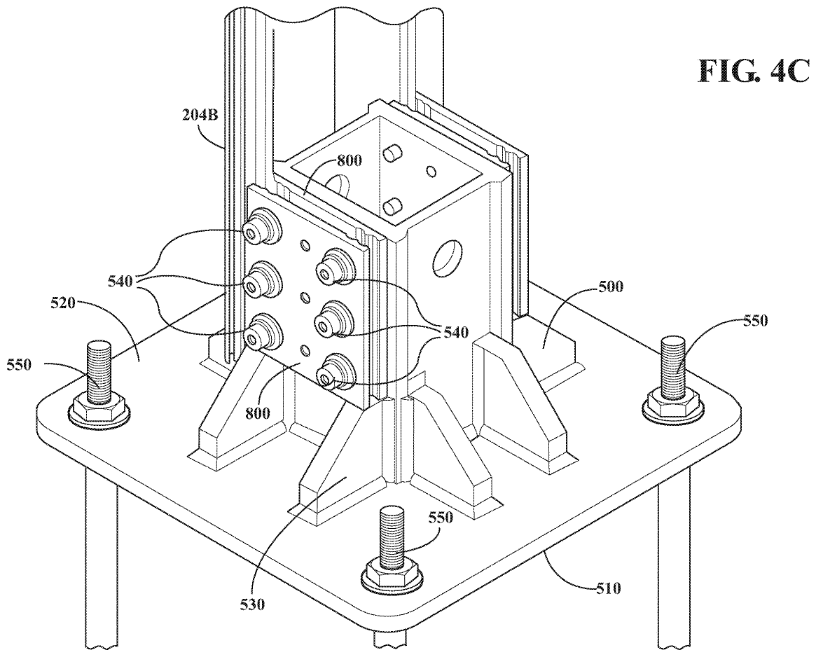

With reference to FIGS. 2-4, the vertical support beam apparatus 200 is specifically designed for use in the modular structure 100. The vertical support beam apparatus 200 comprises a first pair of identical elongated plates 204 and a second pair of identical elongated plates 202. The first pair of elongated plates 204 is curved to provide structural rigidity to the component and the vertical support beam apparatus 200. In embodiments, each plate in the first pair of elongated plates 204 features a first groove 208 along the first lateral edge 216 and a second groove 210 along the second lateral edge 218. In addition, each plate in the second pair of the elongated plates 202 is equipped with a first protrusion 212 along the first lateral edge 216 and a second protrusion 214 along the second lateral edge 218. The second pair of elongated plates 202 includes multiple holes 215 for connecting to the first pair of elongated plates 204, as will be explained, as well as other components or parts to the modular structure 100. In some embodiments, there may be additional grooves and protrusions for more secure connections between the components. These grooves and protrusions are strategically configured to interlock with each other to form a support column of the vertical support beam apparatus 200. This will create a secure and stable structure of the vertical support beam apparatus 200 portion of the modular structure 100, and a connection between the plates.

When assembled, the first lateral edge 216 of each plate in the first pair interlocks with the first lateral edge 216 of a corresponding plate in the second pair. Similarly, the second lateral edge 218 of each plate in the first pair interlocks with the second lateral edge 218 of a corresponding plate in the second pair. This interlocking mechanism results in the formation of an assembled beam characterized by a rounded overall shape when viewed in cross-section. The design of this vertical support beam apparatus 200 is intended to provide structural integrity and support, making it suitable for the dynamic environment of a carwash.

In an embodiment, the assembled vertical support beam apparatus 200 is held together with fasteners 219, such as nuts and bolts, where the nut element includes protrusions and recesses that correspond to the protrusions and recesses of the first and second elongated plates 202, 204, thus forming a locking structure that strongly locks the first and second elongated plates 202, 204 together. In other embodiments, the assembled vertical support beam apparatus 200 may be connected or fixed by other means known to those of skill in the art.

Advantageously, in an embodiment, at least some of the components of the vertical support beam apparatus 200 are made of extruded aluminum. This form of construction provides a strong, cost-effective structure that is resistant to outdoor weather, including rain and snow. It also provides for a lighter-weight construction of the vertical support beam apparatus 200 and overall modular structure 100. It also creates an extremely strong modular structure 100 that is able to withstand extreme wind conditions. This makes the modular structure 100 particularly suitable for all geographical locations, including areas with a risk of high winds and hurricanes. The described modular structure 100 exceeds extreme wind rating requirements.

The ability to assemble the structure of the vertical support beam apparatus 200 allows for easier shipping of the component parts. This is an advantage to carwashes that require multiple units of the modular structure. It allows for lower shipping costs due to the lower weight and volume of materials required to assemble the modular structure 100. Due to the components'shape and structure, they can easily be stacked on a truck, taken to the location, and assembled onsite.

In some embodiments, the vertical support beam apparatus 200 may include flexible, translucent materials such as composite plastics, bamboo, hemp-based composites, mycelium insulation, PVC, and recycled materials to create an innovative covering system for the vertical support beam apparatus 200, particularly in environments like carwashes. These materials are designed to slide onto or snap onto the surface of the vertical support beam apparatus 200, providing both protection and aesthetic enhancement. This includes the ability to use flat materials, which cost less than pre-formed shapes. Lower costs and ease of installation allow a carwash owner to change out the materials as desired.

When assembled, the vertical support beam apparatus 200 may be formed into a beam with a rounded cross-section and two opposing longitudinal valleys 220. The valleys 220 include indents 222 suitable for creating a snap-in area for material coverings of the types described above. In an embodiment, the valleys 220 are suitable for lights, such as a string of LED lights. Other lights known to those of skill in the art are applicable. The lights can be placed in the valleys 220, and then a translucent material can be snaped into the indents 222, thus creating a protective cover and light dispersal mechanism. With or without lights, the valleys 220 may be protected by a sheet of the flexible translucent material and may then serve a dual purpose: they not only enhance the appearance of the beam but also offer a protected channel for installing lights, wiring, and other utilities, safeguarding them from environmental exposure while maintaining an elegant and seamless appearance. This system allows for easy installation and maintenance, making it a practical solution for modern architectural and industrial applications.

The vertical support beam apparatus 200 may further comprise a cover-snapping interface comprising a series of T-shaped components 224 strategically positioned on the surface of the beam. These components are designed to securely receive flexible sheets that slide or snap into place, thereby providing a protective covering for the beam. Again, it is an advantage that flat, non-preformed materials can be bent to slide into the sides of the T-shaped components 224, thus allowing the use of less expensive materials than pre-formed materials with a specific curvature or design. The T-shaped components 224 allow for the cover materials to be placed on four sides of the vertical support beam apparatus 200. The materials can be customized to include lettering such as the name of the carwash or other information.

In addition, the T-shaped components 224 provide additional anchoring points for attaching other components and enhance the stability of the flexible materials once in place. This configuration not only secures the materials but also allows for easy installation and removal when necessary.

In an embodiment, the vertical support beam apparatus 200 is secured in place with the base 500. In an embodiment, the base 500 is secured with a base platform 510. The base platform 510 includes a plate 520 and a vertical support structure 530 attached to the plate 520. In an embodiment, the vertical support structure 530 fits within the vertical support beam apparatus 200 and is held in place by a series of fasteners 540, such as nuts and bolts, that connect an interlocking plates 800 to the vertical support structure 530 and to the first pair of elongated plates 204. Other means of attachment are contemplated within the skill of the art. The base platform 510 of the base 500 is fixed to a foundation, such as a concrete foundation, with foundational fasteners 550. The concrete foundation may be buried in the ground. Other suitable ways of fixing the base 500 are considered within the scope of the disclosure.

Overall, the vertical support beam apparatus 200 combines functionality with durability. The interlocking plate design ensures a robust assembly, while the rounded cross-section and longitudinal valleys provide both practical and aesthetic benefits. This technology is intended to enhance the efficiency and reliability of carwash systems by providing a stable support structure that withstands frequent use and exposure to water and cleaning agents.

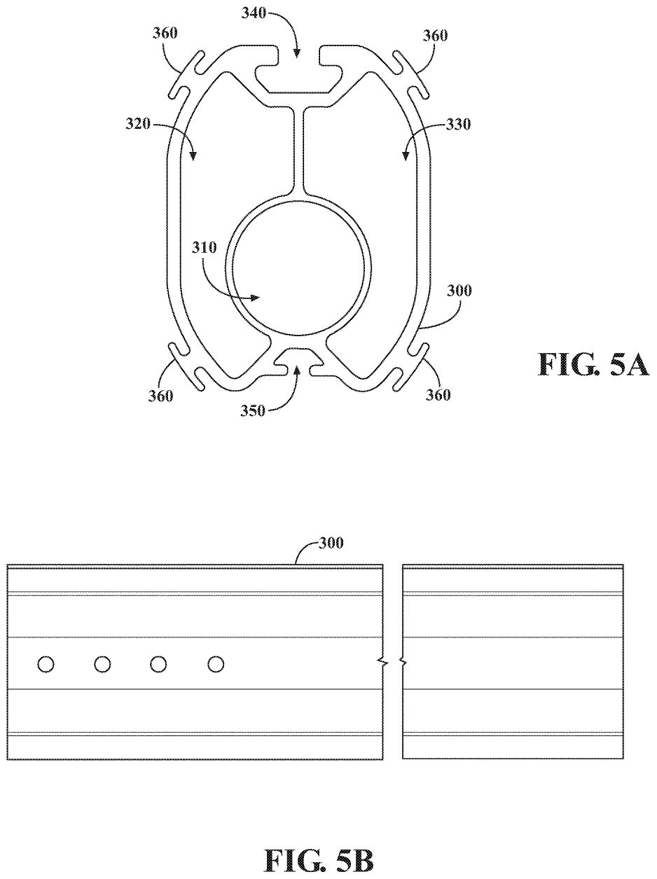

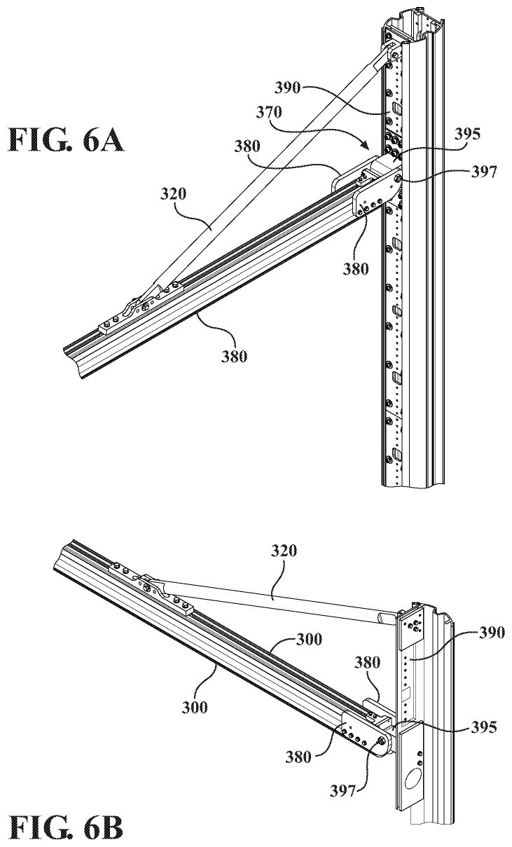

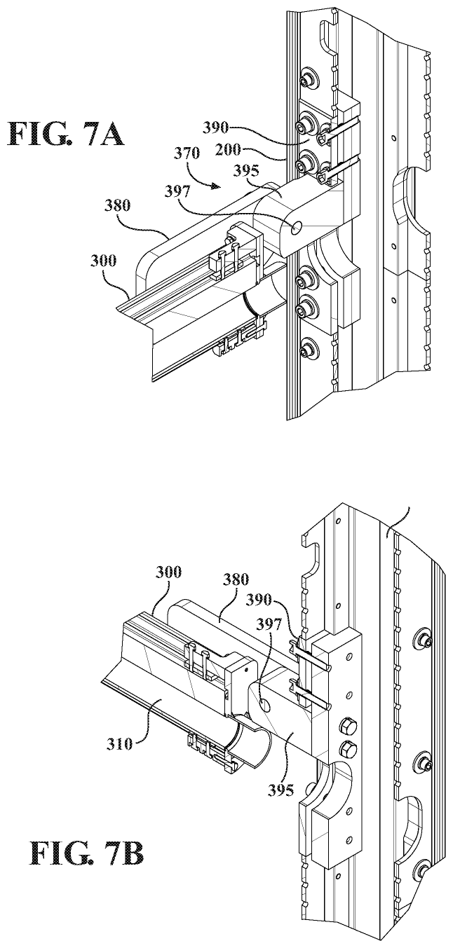

With reference to FIGS. 5-7, the lateral support beam 300 attaches perpendicularly to the vertical support beam apparatus 200. It should be appreciated that there is no requirement for a perpendicular association between the vertical support beam apparatus 200 and the lateral support beam 300. In an embodiment, one of the components could be at a different angle than 90 degrees from the other. This configuration option allows for customizing the arrangement of the lateral support beam 300 and the vertical support beam apparatus 200. As a further example of a contemplated embodiment involving multiple modular structures 100 connected together, the lateral support beams 300 can be at differing angles relative to the vertical support beam apparatuses 200. This provides a customizable aesthetic appeal that allows one carwash to distinguish itself from another.

In some embodiments, the lateral support beam 300 may comprise a secondary lateral support beam 320 configured to stabilize the angle between the lateral support beam 300 and the vertical support beam apparatus 200. In some embodiments, the lateral support beam 300 for a carwash comprises an innovative structural component designed to enhance the functionality and efficiency of carwash systems. In some embodiments, the lateral support beam 300 comprises a single-piece elongated beam member, which provides robust structural support while incorporating advanced features to facilitate various carwash operations. The lateral support beam 300 comprises an internal compartment 310 that extends longitudinally along its entire length. In some embodiments, the compartment is configured to facilitate airflow, allowing it to serve as a conduit for air movement, which can be integral in various carwash processes, such as vacuuming. In an embodiment, the internal compartment 310 is a vacuum line. The lateral support beam 300 may include more than one interior space, including a first 320 and a second 330 interior space. The first 320 and the second 330 interior spaces may be adapted to provide an additional airflow conduit or space for wiring or other components of a carwash system. The structure of the lateral support beam 300 provides both an aesthetic appearance and solid structural integrity.

The lateral support beam 300 may also include a top recess 340 and a bottom recess 350 adapted to provide a secure location for routing wires, cables, or other devices. In an embodiment, the top recess 340 and bottom recess 350 may include lighting such as a string of LED lights or other lighting systems well known in the art.

The lateral support beam 300 also includes T-shaped members 360, which are adapted to allow decorative materials, such as a sheet of translucent material, to be inserted or snapped into place to add a customizable aesthetic component to the overall appearance of the modular structure 100.

The lateral support beam 300 is pivotably attached to the vertical support beam apparatus 200 by a mounting assembly 370. The mounting assembly 370 includes a first attachment plate 380 attached to the lateral support beam 300, a second attachment plate 390 attached to the vertical support beam apparatus 200, and a pivot block 395 connected to the second attachment plate 390. A pivot pin 397 associates the pivot block 395 with the first attachment plate 380. Thus, the lateral support beam 300 can pivot in relation to the vertical support beam apparatus 200, advantageously allowing for using the lateral support beam for a combination of purposes, including a vacuum line, pivoting canopy assembly, decorative element, and customizable assembly.

In an embodiment, the lateral support beam 300 is made from extruded aluminum. As described in relation to the vertical support beam apparatus 200, there are multiple advantages to this type of construction, including its weight and structural strength. Its modular construction, along with other components of the described modular structure, makes it easier to ship and assemble.

In some embodiments, the lateral support beam 300 may comprise a canopy attachment interface located on its external surface. This interface may be engineered to support an overhead canopy, providing essential coverage and protection for vehicles and equipment within the carwash. The canopy not only shelters the area from environmental elements but also contributes to the aesthetic appeal and operational efficiency of the carwash. The interface may be configured to ensure a secure and stable attachment of the canopy, which may enhance the durability and reliability of the overall structure.

Additionally, the lateral support beam 300 includes a vacuum connection interface 560, which is strategically positioned on the end points of the elongated beam member, with one end connected to the vacuum source and one end connected to the vacuum head. In some embodiments, the vacuum connection interface 560 is configured for a hinged connection to a vacuum source, allowing for flexibility and ease of use. The design ensures that the internal compartment 310 of the beam is in fluid communication with the vacuum connection interface 560. In some embodiments, the application of a vacuum at the interface effectively draws air through the internal compartment, facilitating efficient air movement along the length of the beam. This feature can be particularly advantageous for removing moisture or debris, thus maintaining the integrity of the vacuum's functionality.

In some embodiments, the lateral support beam 300 represents a multifunctional component that integrates structural support with advanced airflow management capabilities. In some embodiments, the design is configured to enhance the operational efficiency of carwash systems and may also be configured to maintain their structural integrity and aesthetic value. By incorporating features such as the canopy attachment interface and vacuum connection interface 560, the lateral support beam 300 offers a versatile solution that addresses multiple needs within a carwash setting. This innovative approach to carwash infrastructure leads to improved performance, reliability, and user experience.

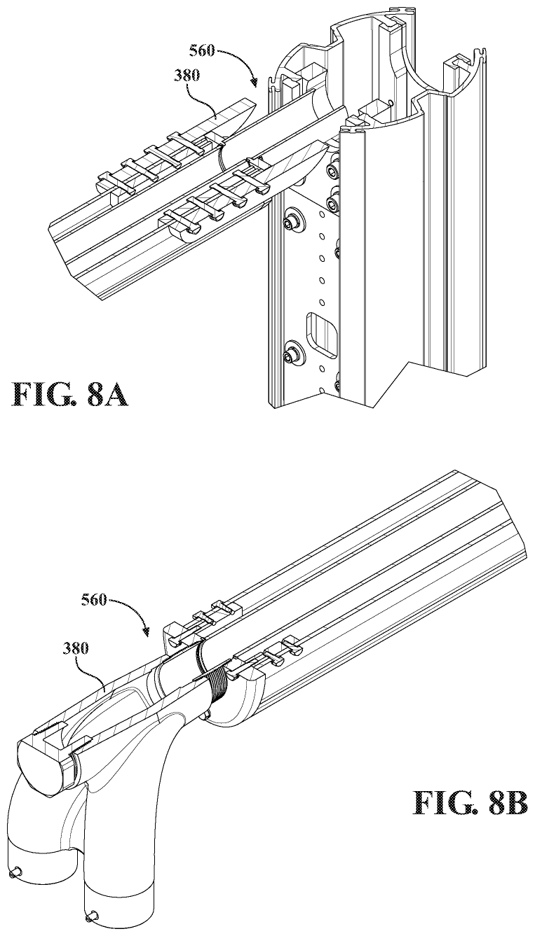

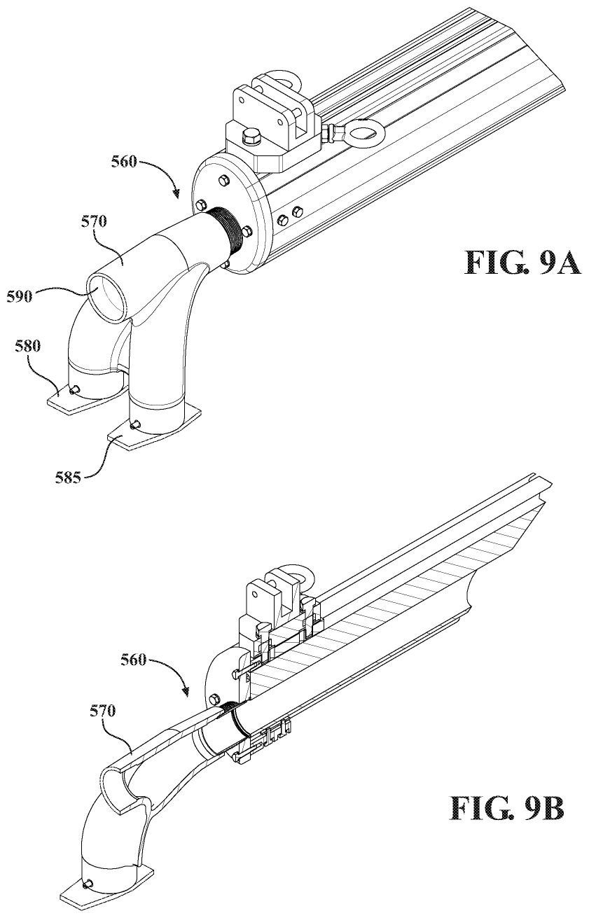

With added reference to FIGS. 8 and 9, the lateral support beam 300 includes an interface 560 that allows connecting to a flexible vacuum hose (not shown) used for cleaning a vehicle. The interface 560 includes a first cap 580 and a second cap 585 to prevent loss of vacuum pressure if not used. The interface 560 also includes an end orifice allowing for cleaning out the internal compartment 310 along the lateral support beam 300.

In some embodiments, the internal compartment 310 of the lateral support beam 300 is configured to maintain an effective air seal at its endpoints, ensuring optimal performance in preserving suction between the vacuum hose and the vacuum source. This is achieved at least in part by using flexible materials in the couplings, which accommodate slight movements and vibrations while maintaining a robust seal, thereby preventing air leakage. Additionally, in an embodiment, the internal compartment 310 may be lined with an airtight material that acts as an additional barrier to ensure the integrity of the vacuum seal throughout the length of the beam. This airtight material may assist in maintaining consistent suction by preventing external air from entering the compartment, which could otherwise disrupt the vacuum pressure. The seamless integration of these structural components allows the internal compartment 310 to efficiently channel air from the vacuum connection interface 560 along the entire length of the elongated beam member 300, which may assist with the overhead canopy remaining supported and operational.

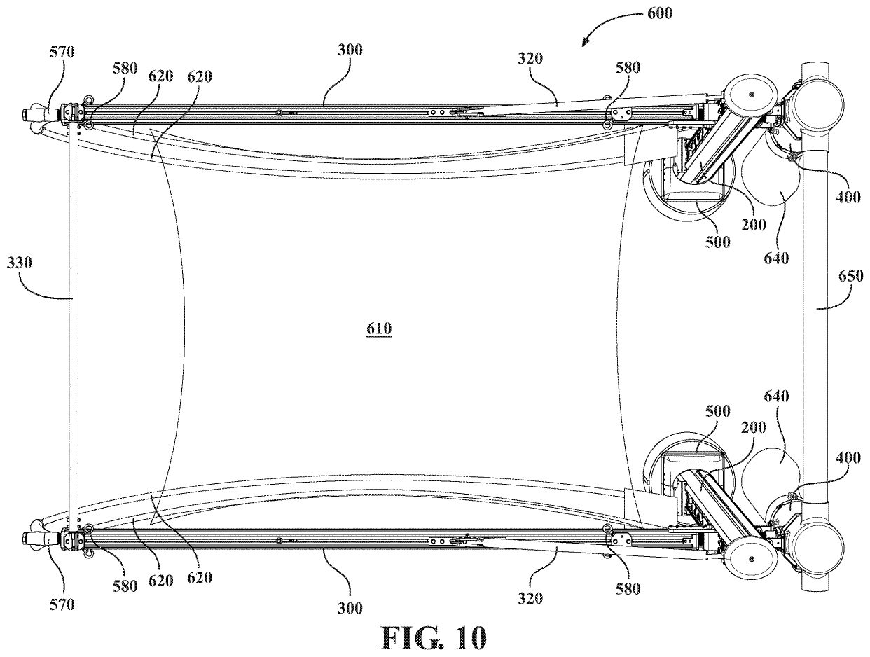

With reference to FIG. 10, in an embodiment, more than one of the modular structures 100 is configured in a carwash system 600. In this configuration, the lateral support beam 300 can serve dual functions: structural support and airflow management for the modular structure 100 of the carwash system 600. The structural support feature of the lateral support beam 300 is a single-piece, elongated beam member. The external surface of the beam is equipped with a canopy attachment interface 580 at least at four points on the lateral support beam 300, thus allowing for secure attachment of an overhead canopy 610. This setup allows the formation of a rectangular area of overhead material of the canopy 610 that provides shade, effectively covering the space between two parallel lateral support beams. This innovative integration of structural support and vacuum airflow management makes the apparatus particularly suitable for environments like a carwash, where both shade and air circulation are beneficial. The carwash system 600 includes vacuum hoses 620 connected at the valve 570 of the interface 560. The carwash system 600 further includes trash receptacles 640 under each of the collection chambers 420. This allows the use of the trash receptacles 640 for the dual purpose of allowing users of the carwash system 600 to put trash in the receptacles and to dump the contents of the collection chambers 420 into them.

The canopy 610 of the carwash system 600, as depicted in FIG. 10, is supported by the lateral support beam 300. Attached to the lateral support beam 300 is the canopy support beam 330, which serves as part of the structural framework for the overhead canopy 610. This configuration ensures stability and support for the canopy, enhancing the overall functionality and durability of the modular structure 100. The vertical support beam apparatus 200 and the debris collection apparatus 400 are also integral to the system, contributing to its comprehensive design and operation.

Connecting each of the two debris collection apparatuses 400 together is a vacuum tube 650. The vacuum tube 650 provides a single vacuum source to service multiple modular structures 100, including each debris collection apparatus 400. As anticipated, if there are multiple modular structures 100, there will be multiple vacuum tubes 650 connecting each debris collection apparatus 400 to the next.

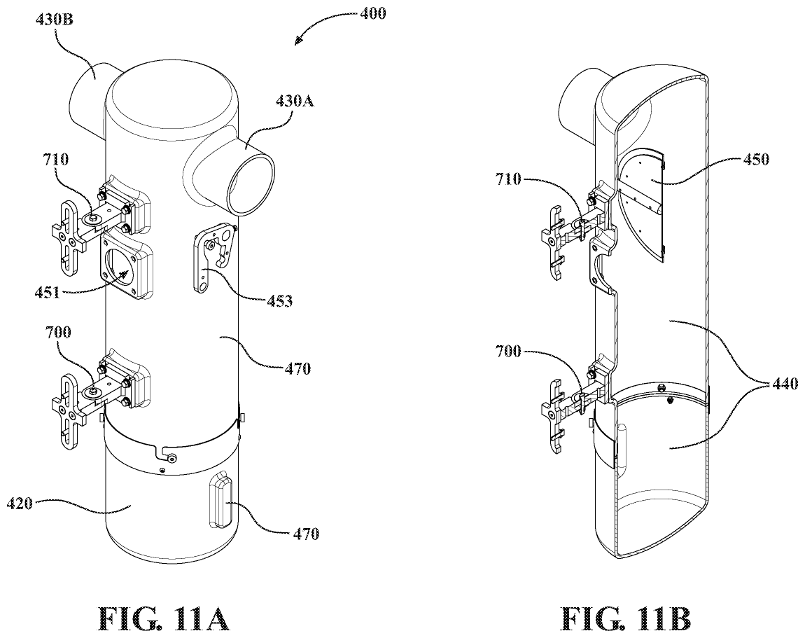

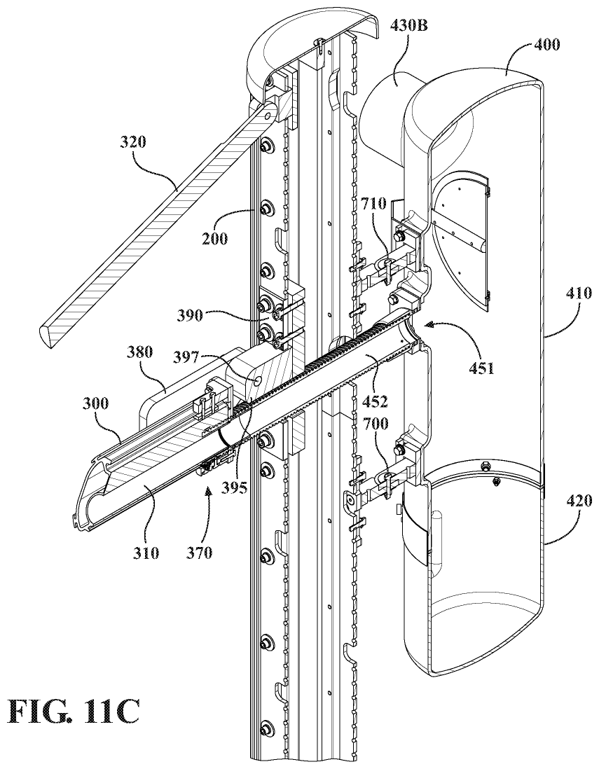

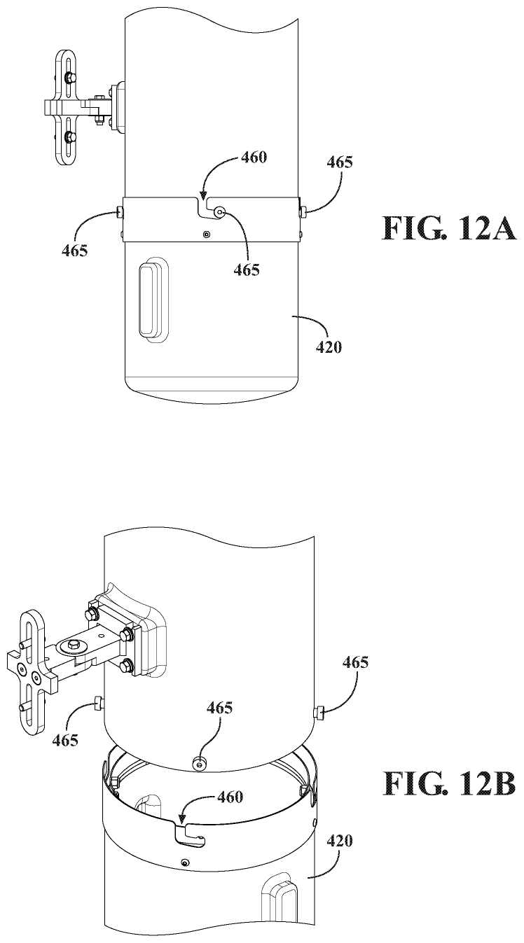

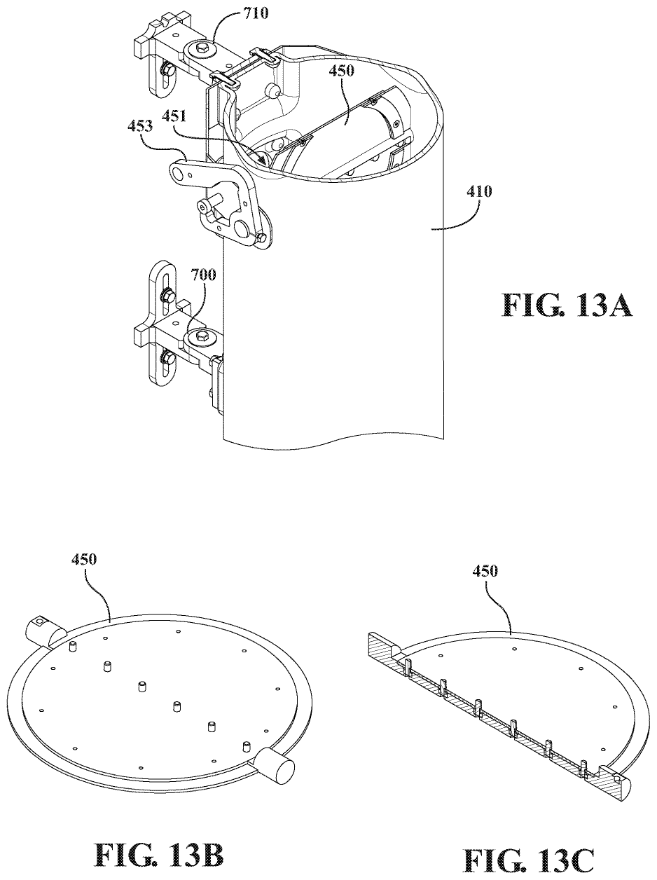

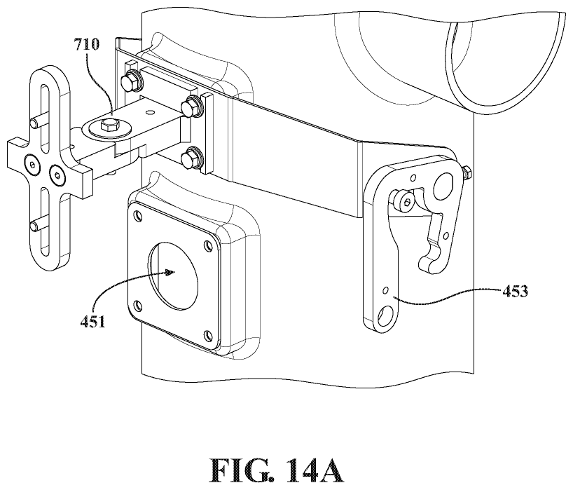

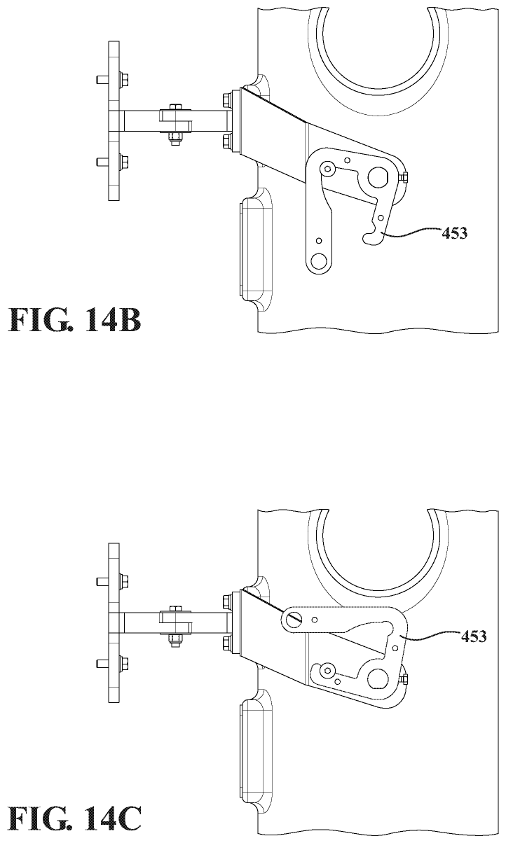

With reference to FIGS. 11A-14C, the debris collection apparatus 400 comprises a top portion 410, a bottom portion 420, a first vacuum port 430A, a second vacuum port 430B, a vacuum shutoff valve 450, and a vacuum connector port 451 for connecting a vacuum through a flexible tube 452 to the internal compartment 310 of the lateral support beam 300 to the vacuum hoses 620. Advantageously, the first vacuum port 430A and the second vacuum port 430B allow for a vacuum to pass from a vacuum source to each of the several of the debris collection apparatuses 400. It is another advantage that the flexible tube 452 is adapted to flex, thus allowing for the collection apparatus 400 to pivot on the vertical support beam 200. The flexible tube 452 is made of suitable materials known to those of skill in the art, including but not limited to plastics, metals, rubbers, and combinations thereof.

In some embodiments, the carwash system 600 may comprise the debris collection apparatus 400, which is specifically designed for use in carwash facilities. This debris collection apparatus 400 comprises a cylindrical body that defines an internal collection chamber 440, which serves as the primary receptacle for collecting and storing debris generated through vacuuming vehicles using the carwash system 600. The cylindrical body design optimizes space utilization and efficiently contains debris, reducing the need for frequent maintenance and emptying. The internal collection chamber 440 is adapted to collect various debris types typically encountered in carwashes, such as dirt, grime, and small particles, ensuring a clean and effective operation.

In some embodiments, the debris collection apparatus 400 comprises the first vacuum port 430A and the second vacuum port 430B on the cylindrical body. In some embodiments, the first vacuum port 430A and the second vacuum port 430B are interchangeable based on how the debris collection apparatus 400 is installed in relation to a vacuum source (not shown), which would be of the types commonly used in applications for industrial vacuum systems, such as found at a carwash. In some embodiments, the first vacuum port 430A is configured to connect seamlessly to an external vacuum source, facilitating the efficient suction of debris into a collection chamber 420. The first vacuum port 430A is strategically positioned to maximize airflow and debris intake, thus enhancing the overall efficiency of the debris collection process. In some embodiments, the second vacuum port 430B returns air sucked through the lateral support beam 300. This configuration ensures that debris is swiftly and effectively removed from the modular structure 100, thus maintaining the cleanliness and functionality of the carwash facility.

In some embodiments, the debris collection apparatus 400 comprises a vacuum shutoff valve 450 and a valve handle 453 that is operatively associated with it. This vacuum shutoff valve 450 may be configured to selectively open and close the vacuum passing through the system, thereby controlling the airflow from the vacuum source by rotating the valve handle 453. By regulating airflow, the vacuum shutoff valve 453 disconnects the vacuum, enabling the removal and emptying of the collection chamber 420. This is particularly advantageous when a user of the system accidentally vacuums up an object that they wanted to keep. The vacuum system allows for turning off the vacuum for just one station of the carwash system 600 and removing the collection chamber 420 to retrieve the lost article without disabling the system for other stations of the carwash system 600. This feature offers a significant advantage as it is a frequent occurrence at a carwash vacuum station for someone to accidentally lose a valued article.

The collection chamber 420 is configured for easy removal and emptying by simply rotating it using two handles 470 to release it from a pin 455 and a recess 460. The upper portion 410 of the cylindrical body is configured to be positioned at an elevated height relative to a support surface. This design allows for the collection chamber 420 to be easily accessible for debris removal without necessitating substantial vertical displacement of the entire canister. As a result, the apparatus offers a user-friendly solution that minimizes downtime and enhances the overall efficiency of carwash operations.

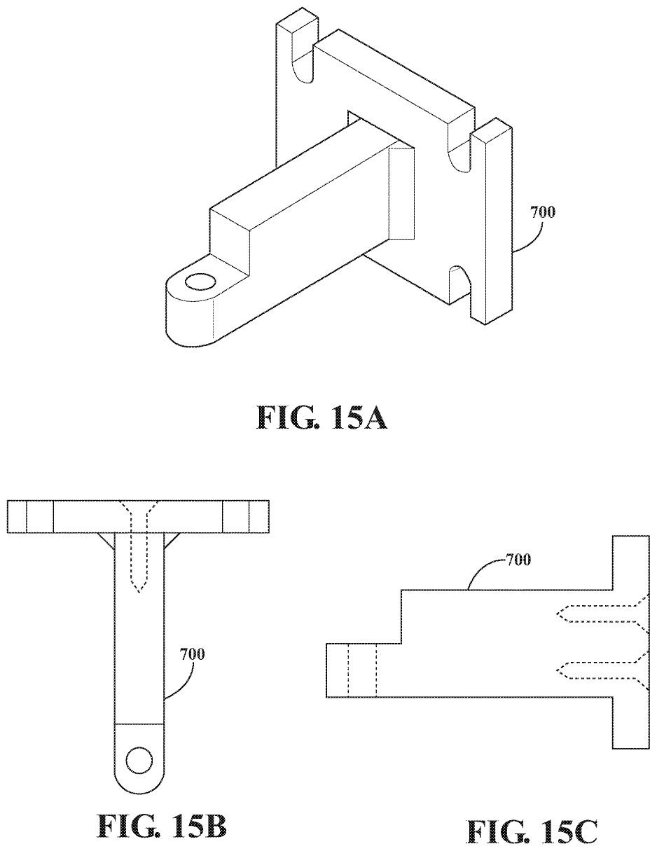

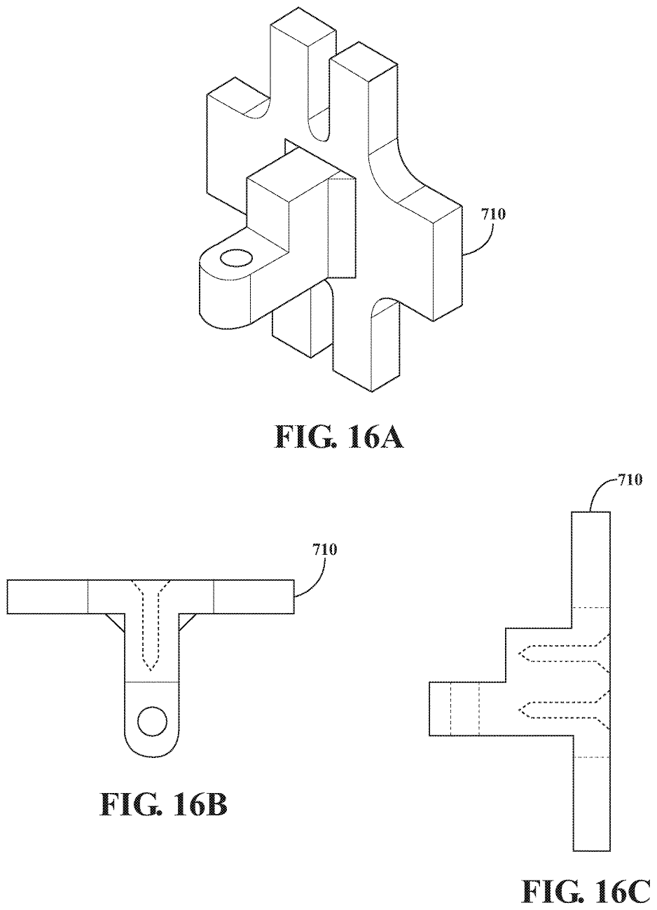

With added reference to FIGS. 15-16, a bottom hinge 700, and a top hinge 710 are used to pivotably connect the debris collection apparatus 400 to the vertical support beam apparatus 200. The debris collection apparatus 400 is securely attached to the vertical support beam apparatus 200 through the use of the top hinge 710 and the bottom hinge 700, both of which are linearly aligned along a vertical axis of the cylindrical body of the debris collection apparatus 400. These hinges allow the debris collection apparatus 400 to pivot or swing as necessary. Importantly, this also allows for several of the modular structures 100 to be aligned together with one debris collection apparatus 400 connected to another in sequence through one or more of the vacuum tubes 650. Advantageously, the hinges allow the modular structures 100 of the carwash system 600 to be angled so that vehicles can pull into a cleaning station at an angle rather than perpendicular to the vehicle's line of travel. The hinges, together with the positioning of the debris collection apparatus 400 on each vertical support apparatuses 200 allow the first vacuum port 430A and second vacuum port 430B to line up for each section of the vacuum tube 650. This allows for greater creativity in the set up of any carwash system 600 of the disclosure. It also allow for accommodating the carwash parking space limitations.

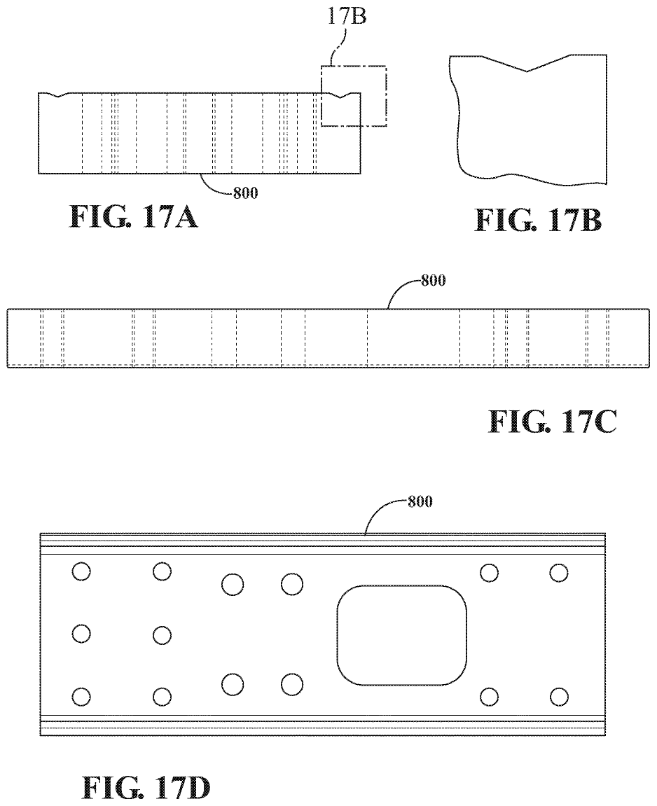

With reference to FIGS. 17A-17C, these is an alternative embodiment of the flat plate 800 used for constructing the vertical support beam apparatus 200. In an alternative embodiment, the vertical support beam apparatus 200 further comprises at least one elongated plate 800 featuring rounded rectangular windows strategically positioned along its length. These windows are configured to provide convenient access to the internal compartment 310 of the vertical support beam apparatus 200, thereby facilitating standard maintenance and repair tasks. Each elongated plate maintains the essential structural characteristics, such as the first and second lateral edges equipped with grooves or protrusions for interlocking with corresponding plates to form the assembled beam. The rounded rectangular windows are configured to ensure that they do not compromise the structural integrity of the beam while allowing users to perform necessary inspections, cleaning, and repairs of the internal components without the need for complete disassembly.

Several embodiments have been discussed in the foregoing description. However, the embodiments discussed herein are not intended to be exhaustive or limit the invention to any particular form. All of the embodiments are meant to be non-limiting. The terminology which has been used is intended to be in the nature of words of description rather than of limitation. Many modifications and variations are possible in light of the above teachings and the invention may be practiced otherwise than as specifically described.

What is claimed is:

1. A vertical support beam apparatus for a carwash, the apparatus comprising:
a first pair of identical elongated plates, each plate having a first lateral edge and a second lateral edge, and a first groove along the first lateral edge and a second groove along the second lateral edge;
a second pair of identical elongated plates, each plate having a first lateral edge and a second lateral edge, and a first protrusion along the first lateral edge and a second protrusion along the second lateral edge configured to interlock with the first groove and second groove of the first pair of plates;
wherein the first lateral edge of each plate in the first pair of plates is interlocked with the first lateral edge of a plate in the second pair of plates and the second lateral edge of each plate in the first pair of plates is interlocked with the second lateral edge of a plate in the second pair of plates to form an assembled beam;
wherein the assembled beam has a rounded overall shape in cross-section; and
wherein the assembled beam defines two opposing longitudinal valleys along its outer surface.

2. A lateral support beam for a carwash, the apparatus comprising:
a single-piece elongated beam member defining an internal compartment extending longitudinally along the length of the beam member, the internal compartment configured to facilitate airflow;
a canopy attachment interface on an external surface of the elongated beam member, configured to support an overhead canopy;
a vacuum connection interface on the elongated beam member, configured for hinged connection to a vacuum source; and
wherein the internal compartment is in fluid communication with the vacuum connection interface such that the application of a vacuum at the vacuum connection interface draws air through the internal compartment along the length of the elongated beam member.

3. A debris collection apparatus for a carwash, the apparatus comprising:
a cylindrical body defining an internal collection chamber for receiving debris;
a vacuum inlet port located on the cylindrical body, the vacuum inlet port configured for connection to a vacuum source;
a valve mechanism operatively associated with the vacuum inlet port, the valve mechanism configured to selectively open and close the vacuum inlet port to control airflow from a vacuum source;
a base compartment located at a lower portion of the cylindrical body, the base compartment configured for removable access to the internal collection chamber; and
an upper portion of the cylindrical body configured to be positioned at an elevated height relative to a support surface such that the base compartment is accessible for the removal of debris without requiring substantial vertical displacement of the entire canister.

4. A modular vertical support beam apparatus, comprising:
a first plurality of elongated plates, each plate having opposing lateral edges including at least one groove;
a second plurality of elongated plates, each plate having opposing lateral edges including at least one protrusion configured to interlock with the grooves of the first plurality of elongated plates;
wherein the first plurality of elongated plates and the second plurality of elongated plates are interlocked to form an assembled beam;
wherein the assembled beam defines a hollow interior and a rounded exterior cross-sectional profile; and
wherein the assembled beam includes at least one longitudinal recess formed along an outer surface.

5. The apparatus of claim 4, wherein the elongated plates are formed from extruded aluminum.

6. The apparatus of claim 4, wherein the longitudinal recess includes retention features configured to receive a removable cover panel.

7. The apparatus of claim 6, wherein the removable cover panel comprises a translucent material configured to diffuse light.

8. The apparatus of claim 4, wherein the assembled beam includes a plurality of attachment interfaces configured to secure additional structural or aesthetic components.

9. The apparatus of claim 4, wherein the elongated plates are configured to be transported in a disassembled state and assembled at an installation site.

10. A lateral support beam, comprising:
an elongated structural member extending along a longitudinal axis;
an internal compartment extending along at least a portion of the elongated structural member;
at least one vacuum interface in fluid communication with the internal compartment;
wherein the internal compartment is configured to convey airflow under vacuum along the length of the elongated structural member.

11. The beam of claim 10, wherein the elongated structural member comprises a single-piece extrusion.

12. The beam of claim 10, wherein the internal compartment is sealed to maintain vacuum pressure along the length of the beam.

13. The beam of claim 10, further comprising a plurality of internal channels including:
(a) a first channel configured for airflow; and
(b) a second channel configured for routing electrical wiring.

14. The beam of claim 10, further comprising a canopy attachment interface disposed on an outer surface of the elongated structural member.

15. The beam of claim 10, wherein the vacuum interface includes a coupling configured to connect to a flexible vacuum hose.

16. The beam of claim 10, wherein the elongated structural member includes at least one recess configured to receive lighting elements.

17. A debris collection apparatus, comprising:
a body defining an internal collection chamber;
a first vacuum port configured to receive airflow from a vacuum source;
a second vacuum port configured to discharge airflow;
a valve mechanism operatively associated with at least one of the vacuum ports to selectively interrupt airflow; and
a removable collection portion configured to provide access to the internal collection chamber.

18. The apparatus of claim 17, wherein the removable collection portion is detachably secured by a rotational locking mechanism.

19. The apparatus of claim 17, wherein the valve mechanism is configured to isolate airflow to a single vacuum station without interrupting airflow to other stations.

20. The apparatus of claim 17, wherein the body is mounted at an elevated position relative to a support surface to allow access to the removable collection portion.

21. The apparatus of claim 17, further comprising a hinge assembly configured to pivotably connect the debris collection apparatus to a structural support.

22. A modular vehicle service system, comprising:
a plurality of vertical support beam apparatuses according to claim 1;
at least one lateral support beam according to claim 2 extending between at least two of the vertical support beam apparatuses;
a vacuum source;
a plurality of vacuum access interfaces disposed along the lateral support beam; and
at least one debris collection apparatus according to claim 3 in fluid communication with the lateral support beam;
wherein the internal compartment of the lateral support beam distributes vacuum from the vacuum source to the plurality of vacuum access interfaces.

23. The system of claim 22, wherein the lateral support beam functions as both a load-bearing structural member and a vacuum distribution conduit.

24. The system of claim 22, wherein the lateral support beam is pivotably connected to at least one vertical support beam apparatus to allow angular adjustment between adjacent modular units.

25. The system of claim 22, wherein the system is configured for modular expansion by adding additional vertical support beam apparatuses and lateral support beams without modification to existing components.

26. The system of claim 22, wherein each debris collection apparatus is configured to be fluidly connected in series with additional debris collection apparatuses.

27. A method of operating a vacuum system for servicing vehicles, comprising:
generating a vacuum at a centralized vacuum source;
distributing the vacuum through a structural beam having an internal airflow compartment;
providing vacuum access to a plurality of user stations along the structural beam;
selectively interrupting airflow to one of the user stations; and
retrieving material from a debris collection apparatus associated with the interrupted station while maintaining vacuum flow to other stations.

28. The method of claim 27, further comprising isolating a single debris collection apparatus by actuating a valve associated with the apparatus while maintaining vacuum flow through the structural beam.
